(19) United States
(12) Patent Application Publication
(10) Pub. No.: US 2016/0196912 A1
(43) Pub. Date: Jul. 7, 2016

(54) DUAL LAYER WIRE COATINGS

(71) Applicant: SABIC GLOBAL TECHNOLOGIES B.V., Bergen op Zoom (NL)

(72) Inventors: Mark Sanner, Mt. Vernon, IN (US); Kapil Sheth, Mt. Vernon, IN (US); Kouichi Nakashima, Moka (JP)

(73) Assignee: SABIC GLOBAL TECHNOLOGIES B.V., Bergen op Zoom (NL)

(21) Appl. No.: 14/910,363

(22) PCT Filed: May 9, 2014
(86) PCT No.: PCT/US2014/037458

§ 371 Date: Feb. 5, 2016

Related U.S. Application Data
(60) Provisional application No. 61/822,017, filed on May 10, 2013.

(51) Int. Cl. H01F 7/20; H01B 3/44; H01B 3/30; H01B 7/02

(52) U.S. Cl. CPC H01F 7/20; H01B 7/0216; H01B 3/445; H01B 3/306; H01B 7/0291

(57) ABSTRACT

Coatings, especially dual-layer composite coatings, for elongated electrically conductive wire can have a dissipation factor that is less than 1%, when tested at 1 KHz at room temperature and 50% relative humidity. The composite thermoplastic coating can include two distinct layers, one layer preferably being a thermoplastic polyetherimide (PEI) and another layer preferably being a thermoplastic perfluoroalkoxy (PFA). The ratio of the thickness of PEI/PFA can range from more than zero to less than 5.4. The thickness of the composite plastic coating can range from more than zero to less than 200 micrometers. Methods for forming the coatings and coated wires are also described.

### BACKGROUND OF THE INVENTION

The invention relates generally wire coatings and more specifically to dual layer wire coatings.

Magnet wire, also known as enameled wire or winding wire, is typically a conductive metal, such as copper or aluminum, wire coated with a very thin layer of insulation. Magnet wire is used in the construction of transformers, inductors, motors, speakers, hard disk head actuators, potentiometers, electromagnets, and other applications which require tight coils of wire. Magnet wire can be produced in a variety of shapes and sizes. Smaller diameter magnet wire usually has a round cross section. This kind of wire is used for applications such as electric guitar pickups. Thicker magnet wire can be square or rectangular, typically with rounded corners, to provide more current flow per coil length.

There exists a need in magnet wire for a high performance high temperature coating(s) that exhibit robust electrical insulation, long term aging stability, and environmental resistance with mechanical properties conducive for the construction of electric motors. There is also a desire to develop a melt processed coating for which they are applied to an electric conductor without the assistance of solvents or other harmful liquids or chemicals. Furthermore, the application of thermoplastic coatings, as opposed to thermosets, are highly desirable since the coatings on coated wires may be recycled and reprocessed into the application or used to manufacture other products. It is well understood magnet wires have many stringent requirements which have led to the development of many different types. This has led to the commercialization of many different types with different performance features since a single type of magnet wire coating can't meet all the necessary requirements. It is understood each wire construction type has its advantages and disadvantages. With this understanding, there is a current need to develop a magnet wire with the following performance features.

### BRIEF SUMMARY OF THE INVENTION

One embodiment relates to a wire having a composite coating thereon. The wire can be an elongated electrically conductive wire. The wire can be coated with a composite thermoplastic coating having a dielectric constant (Dk) of less than 3, when tested at 1 KHz at room temperature and 50% relative humidity.

Another embodiment relates to a magnet wire having a composite coating thereon. The magnet wire can be an elongated electrically conductive wire. The wire can be coated with a composite thermoplastic coating having a dielectric constant (Dk) of less than 3, when tested at 1 KHz at room temperature and 50% relative humidity. The composite thermoplastic coating can have a dissipation factor that is less than 1%, when tested at 1 KHz at room temperature and 50% relative humidity. The composite thermoplastic coating can include two distinct layers, one layer being a thermoplastic polyetherimide (PEI) and another layer being a thermoplastic perfluoroalkoxy (PFA). The ratio of the thickness of PEI/PFA can range from more than zero to less than 5.4. The thickness of the composite plastic coating can range from more than zero to less than 200 micrometers.

Another embodiment relates to a method of making a magnet wire. The method can include extruding onto an elongated electrically conducting wire a first layer of a thermoplastic polymer into contact with the wire and forming a second layer of a different thermoplastic polymer onto the first layer.

### BRIEF DESCRIPTION OF THE DRAWINGS

These and other features, aspects, and advantages of the present invention will become better understood with reference to the following description and appended claims, and accompanying drawings where:

FIG. 1 is a schematic diagram of a dual coated wire;

FIG. 2 is a chart showing the predicted dielectric constant of a particular dual coating, namely a PFA-PEI coating; and

FIG. 3 is a chart showing dielectric constant versus Polyetherimide Sulfone (PEIS)/PFA thickness ratio for experimental results presented in Table 4.

It should be understood that the various embodiments are not limited to the arrangements and instrumentality shown in the drawings.

### DETAILED DESCRIPTION OF THE INVENTION

The invention is based, in part, on the observation that using a specific combination of materials, it is now possible to make a thermoplastic wire coating that has a combination of electrical, process and mechanical properties that are suitable for many applications. According to certain preferred embodiments, a magnet wire was developed that includes a metal conductor and a dual layer of polyetherimide (PEI) and fluoropolymer (or fluorinated polymer) (FPM). The magnet wire can meet stringent performance criteria. A person skilled in the art will appreciate the difficulty in lowering the dielectric constant (Dk) of a coating comprising a material such as PEI, while maintaining a high continuous use temperature, strength, stiffness, adhesion of the polymer to the conductor, as well as other mechanical, thermal, and environmental properties. This combination of properties in addition to the ability to melt process the coatings without the need of a solvent makes the invention innovative and useful.

According to various embodiments a magnet wire can include a metal conductor and a dual layer of polyetherimide (PEI) and fluoropolymer (FPM). The magnet wire, according to various embodiments, meets stringent performance criteria.

Referring to FIG. 1, an exemplary dual layer wire coating construction 1 is shown. A metal conductor 2 is shown. Magnet wire, also known as winding wire outside the United States, can use circular or rectangular metal conductors in there construction. The construction shown in FIG. 1 is for illustrative purposes and is not limiting the invention to a rectangular cross section with dimensions as indicated. The spirit of the invention is to include magnet wire with an electrical conductor, preferably a metal conductor of any geometry and is not dimensionally specific. However, the coating thickness is preferably less than 500 micrometers and more preferably less than 100 micrometers. The metal conductor 2 is surrounded by a thermoplastic coating, forming an innermost layer 3, which is in direct contact with the metal conductor. The innermost layer 3 can be a polyetherimide material, such as ULTEM® XH6050. The innermost layer 3 can be surrounded by a coating forming an outer layer 4. The outer layer 4 can be a fluoropolymer, such as DuPont® PFA (Perfluoroalkoxy). Non-limiting examples of other suitable fluorinated polymers, in addition to perfluoroalkoxy resins, can include polytetrafluoroethylenes, fluorinated ethylene-propylene copolymers, polyfluorinated vinylidenes and polychlorotrifluoroethylenes), Other non-limiting examples of possible fluorinated polymers that can include pentafluoroethanes, octafluoropropanes, trifluoromethoxydifluoromethanes or hexafluoro-cyclopropanes, or a mixture of two or more thereof, 1,1,1,2- or 1,1,2,2-tetrafluoroethane, 1,1-difluoroethane, trifluoromethoxypentafluoroethane, 1,1,1,2,3,3-heptafluoropropane, perfluoroalkoxy ethylenes, such as those disclosed in U.S. Pat. No. 6,927,259, incorporated herein in its entirety, mixtures of the foregoing. A skilled artisan will be familiar with other fluorinated polymers.

The outer layer 4 can be in direct contact with the innermost layer 3. Additional layers can surround the outer layer 4, or the outer layer can be exposed to the external surroundings.

The metal conductor 2 can have a width 5 and a height 6. In a preferred embodiment, the width 5 can be about 5 mm and the height 6 can be about 1.6 mm. The innermost layer 3 and the outermost layer 4 can have a combined thickness 7. In a preferred embodiment, the combined thickness 7 can be about 50 to 100 μm. An innermost layer 3 comprising PEI can have a Dk of about 3.2. An outermost layer comprising perfluoroalkoxy (PFA) can have a Dk of 2.1. The PEI-PFA magnet wire construction can result in an effective Dk that ranges between 2.1 to 3.2 dependent on thickness of each individual constituent.

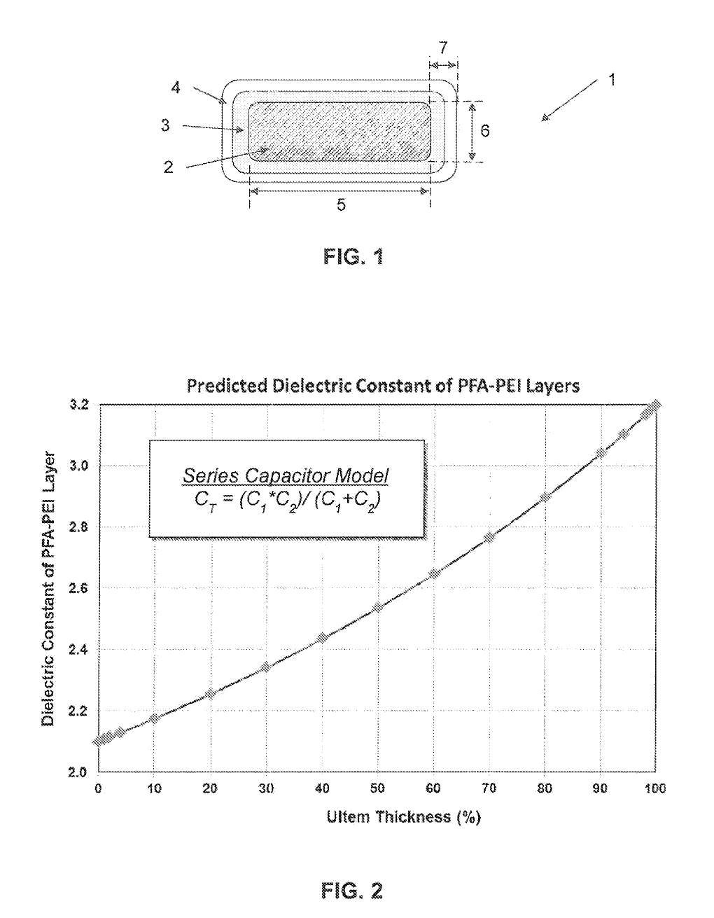

Without wishing to be bound by theory, a theoretical dependence of dielectric constant on a coating thickness for a dual-coated wire is presented in FIG. 2. In this example, a 50 micrometer (2 mil) overall thickness is used with a theoretical model considering individual layers as a capacitor. It is from the defining equations and consideration of capacitors in series for which the overall dielectric constant of the construction may be calculated. Equation 1 defines a theoretical relationship for two capacitors in series.

$${C}_{T} = \frac{{C}_{1} \cdot {C}_{2}}{( {C}_{1} + {C}_{2} )} \qquad Eq . 1$$

In Equation 1, C₁ represents the capacitance of innermost layer 3, C₂ represents the capacitance of outer layer 4, and C_{T} represents the total capacitance of the combined construction. Equation 2 provides the definition of capacitance.

$${C}_{T} = \frac{( {Dk}_{T} \cdot {ɛ}_{0} \cdot A )}{d} \qquad Eq . 2$$

In Equation 2, Dk_{T} represents the overall construction dielectric constant, A represents the surface area of the conductor, e.g., metal, that is covered by the coating, d represents the distance, i.e., the thickness of coating the coating, and ∈₀ is a constant, representing permittivity of a vacuum in free space.

As shown in the theoretical dependence of dielectric constant on coating thickness for a dual-coated wire of FIG. 2, a 50 micrometer PEI-PFA coating with at least 28% PFA (remainder PEI) will reduce the dielectric constant of a 100% PEI coating from 3.2 to 2.8 as required for various applications. Further increasing PFA thickness relative to PEI, while maintaining the overall thickness of 50 micrometers, can further reduce Dk to a minimum of 2.1, which corresponds to 100% PFA. A 50 micrometer overall thickness is not critical in the design from the standpoint of achieving a Dk of <2.8; the Dk performance level is determined by the thickness ratio of the two layers. According to various embodiments, a plurality of different thermoplastic materials may be used for the innermost layer and as well as the outermost layer.

According to various embodiments, either layer, particularly the innermost layer 3, can comprise one or more composite thermoplastics, e.g., amorphous polymers. The one or more amorphous polymers can be selected from polyetherimide, polyetherimide sulfone, polyetherimide siloxanes, polysulfone, polyethersulfone, polyphenylsulfone, polycarbonate, polycarbonate siloxanes, and polyester-polycarbonate as homo-polymers, co-polymers (block and random), and combinations or blends thereof. Either layer, particularly the innermost layer 3 can also comprise one or more semi-crystalline materials. The one or more semi-crystalline materials can be selected from aromatic polyester polymers, including liquid crystal polymers (LCP); polyamides, such as poly [imino(1,6-dioxohexamethylene) imnohexamethylene], i.e., Nylon 6-6; polyether ether ketone (PEEK); polyaryletherketone (PAEK); polyphenylene sulfide (PPS); and any combination thereof. Either layer, particularly the innermost layer 3, can also comprise a combination of an amorphous and semi-crystalline blend as a single layer in the construction.

The addition of colorants (e.g., pigment or dyes) to the coating has been found to be beneficial as some of the coatings are so thin, that in their natural (uncolored) state, it is difficult to visually ascertain their presence.

The composition can include one or more polyetherimides to provide high heat resistance, chemical resistance, according to ASTM D543-06, to multiple reagents, and initial resin color light enough to make bright white, jet black and any other colored products.

The composition can include an amount of polyetherimide within a range having a lower limit and/or an upper limit. The range can include or exclude the lower limit and/or the upper limit. The lower limit and/or upper limit can be selected from 5, 10, 11, 12, 13, 14, 15, 16, 17, 18, 19, 20, 25, 30, 35, 40, 45 and 50 wt. %. For example, according to certain preferred embodiments, the composition can include an amount of polyetherimide of at least 15 wt. %.

The polyetherimide can be a homopolymer or a copolymer.

The polyetherimide can be selected from (i) polyetherimide homopolymers, e.g., polyetherimides, (ii) polyetherimide co-polymers, e.g., siloxane-polyetherimides, polyetherimide sulfones, and (iii) combinations thereof. Polyetherimides are known polymers and are sold by SABIC Innovative Plastics under the Ultem*, EXTEM*, and Siltem* brands (Trademark of SABIC Innovative Plastics IP B.V.).

In one embodiment, the polyetherimides are of formula (1):

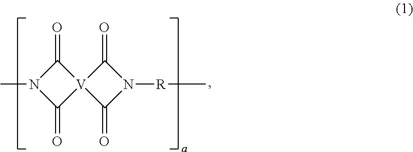

wherein a is more than 1, for example 10 to 1,000 or more, or more specifically 10 to 500.

The group V in formula (1) is a tetravalent linker containing an ether group (a “polyetherimide” as used herein) or a combination of an ether groups and arylene sulfone groups (a “polyetherimide sulfone”). Such linkers include but are not limited to: (a) substituted or unsubstituted, saturated, unsaturated or aromatic monocyclic and polycyclic groups having 5 to 50 carbon atoms, optionally substituted with ether groups, arylene sulfone groups, or a combination of ether groups and arylene sulfone groups; and (b) substituted or unsubstituted, linear or branched, saturated or unsaturated alkyl groups having 1 to 30 carbon atoms and optionally substituted with ether groups or a combination of ether groups, arylene sulfone groups, and arylene sulfone groups; or combinations comprising at least one of the foregoing. Suitable additional substitutions include, but are not limited to, ethers, amides, esters, and combinations comprising at least one of the foregoing.

The R group in formula (1) includes but is not limited to substituted or unsubstituted divalent organic groups such as: (a) aromatic hydrocarbon groups having 6 to 20 carbon atoms and halogenated derivatives thereof; (b) straight or branched chain alkylene groups having 2 to 20 carbon atoms; (c) cycloalkylene groups having 3 to 20 carbon atoms, or (d) divalent groups of formula (2):

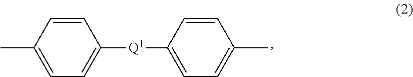

wherein Q¹ includes but is not limited to a divalent moiety such as —O—, —S—, —C(O)—, —SO₂—, —SO—, —C_{y}H_{2y}— (y being an integer from 1 to 5), and halogenated derivatives thereof, including perfluoroalkylene groups.

In an embodiment, linkers V include but are not limited to tetravalent aromatic groups of formula (3):

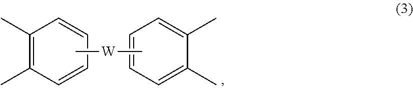

wherein W is a divalent moiety including —O—, —SO₂—, or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent groups of formulas (4):

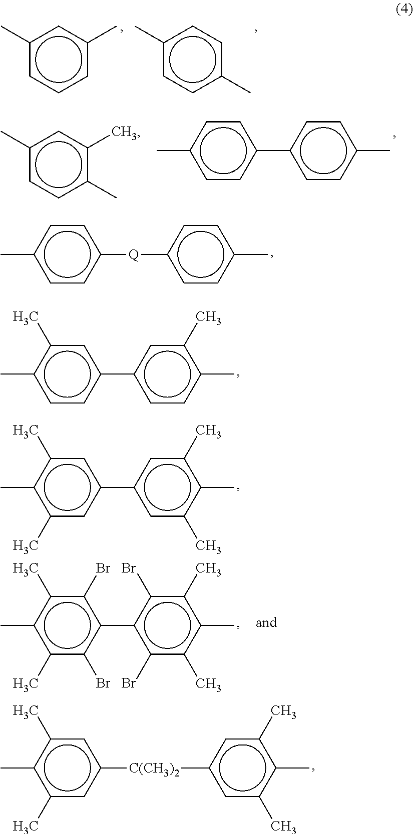

wherein Q includes, but is not limited to a divalent moiety including —O—, —S—, —C(O)—, —SO₂—, —SO—, —C_{y}H_{2y}— (y being an integer from 1 to 5), and halogenated derivatives thereof, including perfluoroalkylene groups.

In a specific embodiment, the polyetherimide comprise more than 1, specifically 10 to 1,000, or more specifically, 10 to 500 structural units, of formula (5):

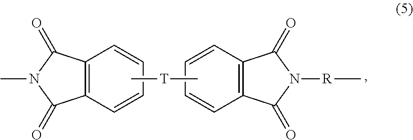

wherein T is —O— or a group of the formula —O—Z—O— wherein the divalent bonds of the —O— or the —O—Z—O— group are in the 3,3′, 3,4′, 4,3′, or the 4,4′ positions; Z is a divalent group of formula (3) as defined above; and R is a divalent group of formula (2) as defined above.

In another specific embodiment, the polyetherimide sulfones are polyetherimides comprising ether groups and sulfone groups wherein at least 50 mole % of the linkers V and the groups R in formula (1) comprise a divalent arylene sulfone group. For example, all linkers V, but no groups R, can contain an arylene sulfone group; or all groups R but no linkers V can contain an arylene sulfone group; or an arylene sulfone can be present in some fraction of the linkers V and R groups, provided that the total mole fraction of V and R groups containing an aryl sulfone group is greater than or equal to 50 mole %.

Even more specifically, polyetherimide sulfones can comprise more than 1, specifically 10 to 1,000, or more specifically, 10 to 500 structural units of formula (6):

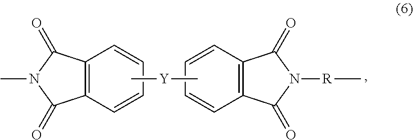

wherein Y is —O—, —SO₂—, or a group of the formula —O—Z—O— wherein the divalent bonds of the —O—, SO₂—, or the —O—Z—O— group are in the 3,3′, 3,4′, 4,3′, or the 4,4′ positions, wherein Z is a divalent group of formula (3) as defined above and R is a divalent group of formula (2) as defined above, provided that greater than 50 mole % of the sum of moles Y+moles R in formula (2) contain —SO₂— groups.

It is to be understood that the polyetherimides and polyetherimide sulfones can optionally comprise linkers V that do not contain ether or ether and sulfone groups, for example linkers of formula (7):

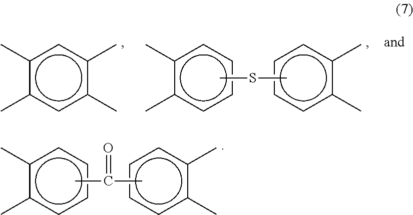

Imide units containing such linkers are generally be present in amounts ranging from 0 to 10 mole % of the total number of units, specifically 0 to 5 mole %. In one embodiment no additional linkers V are present in the polyetherimides and polyetherimide sulfones.

In another specific embodiment, the polyetherimide comprises 10 to 500 structural units of formula (5) and the polyetherimide sulfone contains 10 to 500 structural units of formula (6).

The polyetherimide and polyetherimide sulfones can be prepared by various methods, including, but not limited to, the reaction of a bis(phthalimide) for formula (8):

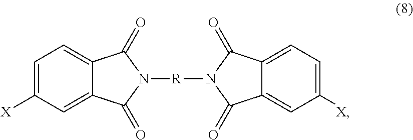

wherein R is as described above and X is a nitro group or a halogen. Bis-phthalimides (8) can be formed, for example, by the condensation of the corresponding anhydride of formula (9):

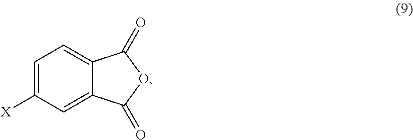

wherein X is a nitro group or halogen, with an organic diamine of the formula (10):

H₂N—R—NH₂ (10),

wherein R is as described above.

Illustrative examples of amine compounds of formula (10) include: ethylenediamine, propylenediamine, trimethylenediamine, diethylenetriamine, triethylenetetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3, 5-diethylphenyl) methane, bis(4-aminophenyl) propane, 2,4-bis(b-amino-t-butyl) toluene, bis(p-b-amino-t-butylphenyl) ether, bis(p-b-methyl-o-aminophenyl) benzene, bis(p-b-methyl-o-aminopentyl) benzene, 1,3-diamino-4-isopropylbenzene, bis(4-aminophenyl) ether and 1,3-bis(3-aminopropyl) tetramethyldisiloxane. Mixtures of these amines can be used. Illustrative examples of amine compounds of formula (10) containing sulfone groups include but are not limited to, diamino diphenyl sulfone (DDS) and bis(aminophenoxy phenyl) sulfones (BAPS). Combinations comprising any of the foregoing amines can be used.

The polyetherimides can be synthesized by the reaction of the bis(phthalimide) (8) with an alkali metal salt of a dihydroxy substituted aromatic hydrocarbon of the formula HO—V—OH wherein V is as described above, in the presence or absence of phase transfer catalyst. Suitable phase transfer catalysts are disclosed in U.S. Pat. No. 5,229,482. Specifically, the dihydroxy substituted aromatic hydrocarbon a bisphenol such as bisphenol A, or a combination of an alkali metal salt of a bisphenol and an alkali metal salt of another dihydroxy substituted aromatic hydrocarbon can be used.

In one embodiment, the polyetherimide comprises structural units of formula (5) wherein each R is independently p-phenylene or m-phenylene or a mixture comprising at least one of the foregoing; and T is group of the formula —O—Z—O— wherein the divalent bonds of the —O—Z—O— group are in the 3,3′ positions, and Z is 2,2-diphenylenepropane group (a bisphenol A group). Further, the polyetherimide sulfone comprises structural units of formula (6) wherein at least 50 mole % of the R groups are of formula (4) wherein Q is —SO₂— and the remaining R groups are independently p-phenylene or m-phenylene or a combination comprising at least one of the foregoing; and T is group of the formula —O—Z—O— wherein the divalent bonds of the —O—Z—O— group are in the 3,3′ positions, and Z is a 2,2-diphenylenepropane group.

The polyetherimide and polyetherimide sulfone can be used alone or in combination. In one embodiment, only the polyetherimide is used. In another embodiment, the weight ratio of polyetherimide:polyetherimide sulfone can be from 99:1 to 50:50.

The polyetherimides can have a weight average molecular weight (Mw) of 5,000 to 100,000 grams per mole (g/mole) as measured by gel permeation chromatography (GPC). In some embodiments the Mw can be 10,000 to 80,000. The molecular weights as used herein refer to the absolute weight averaged molecular weight (Mw).

The polyetherimides can have an intrinsic viscosity greater than or equal to 0.2 deciliters per gram (dl/g) as measured in m-cresol at 25° C. Within this range the intrinsic viscosity can be 0.35 to 1.0 dl/g, as measured in m-cresol at 25° C.

The polyetherimides can have a glass transition temperature of greater than 180° C., specifically of 200° C. to 500° C., as measured using differential scanning calorimetry (DSC) per ASTM test D3418. In some embodiments, the polyetherimide and, in particular, a polyetherimide has a glass transition temperature of 240 to 350° C.

The polyetherimides can have a melt index of 0.1 to 10 grams per minute (g/min), as measured by American Society for Testing Materials (ASTM) DI 238 at 340 to 370° C., using a 6.7 kilogram (kg) weight.

One process for the preparation of polyetherimides having structure (1) is referred to as the nitro-displacement process (X is nitro in formula (8)). In one example of the nitro-displacement process, N-methyl phthalimide is nitrated with 99% nitric acid to yield a mixture of N-methyl-4-nitrophthalimide (4-NPI) and N-methyl-3-nitrophthalimide (3-NPI). After purification, the mixture, containing approximately 95 parts of 4-NPI and 5 parts of 3-NPI, is reacted in toluene with the disodium salt of bisphenol-A (BPA) in the presence of a phase transfer catalyst. This reaction yields BPA-bisimide and NaNO₂ in what is known as the nitro-displacement step. After purification, the BPA-bisimide is reacted with phthalic anhydride in an imide exchange reaction to afford BPA-dianhydride (BPADA), which in turn is reacted with meta-phenylene diamine (MPD) in ortho-dichlorobenzene in an imidization-polymerization step to afford the product polyetherimide.

An alternative chemical route to polyetherimides having structure (1) is a process referred to as the chloro-displacement process (X is Cl in formula (8)). The chloro-displacement process is illustrated as follows: 4-chloro phthalic anhydride and meta-phenylene diamine are reacted in the presence of a catalytic amount of sodium phenyl phosphinate catalyst to produce the bischlorophthalimide of meta-phenylene diamine (CAS No. 148935-94-8). The bischlorophthalimide is then subjected to polymerization by chloro-displacement reaction with the disodium salt of BPA in the presence of a catalyst in ortho-dichlorobenzene or anisole solvent. Alternatively, mixtures of 3-chloro- and 4-chlorophthalic anhydride may be employed to provide a mixture of isomeric bischlorophthalimides which may be polymerized by chloro-displacement with BPA disodium salt as described above.

Siloxane polyetherimides can include polysiloxane/polyetherimide block copolymers having a siloxane content of greater than 0 and less than 40 weight percent (wt %) based on the total weight of the block copolymer. The block copolymer comprises a siloxane block of Formula (I):

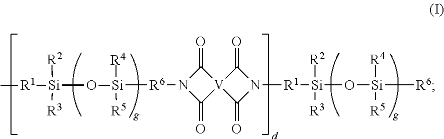

wherein R¹⁻⁶ are independently at each occurrence selected from the group consisting of substituted or unsubstituted, saturated, unsaturated, or aromatic monocyclic groups having 5 to 30 carbon atoms, substituted or unsubstituted, saturated, unsaturated, or aromatic polycyclic groups having 5 to 30 carbon atoms, substituted or unsubstituted alkyl groups having 1 to 30 carbon atoms and substituted or unsubstituted alkenyl groups having 2 to 30 carbon atoms, V is a tetravalent linker selected from the group consisting of substituted or unsubstituted, saturated, unsaturated, or aromatic monocyclic and polycyclic groups having 5 to 50 carbon atoms, substituted or unsubstituted alkyl groups having 1 to 30 carbon atoms, substituted or unsubstituted alkenyl groups having 2 to 30 carbon atoms and combinations comprising at least one of the foregoing linkers, g equals 1 to 30, and d is 2 to 20. Commercially available siloxane polyetherimides can be obtained from SABIC Innovative Plastics under the brand name SILTEM* (*Trademark of SABIC Innovative Plastics IP B.V.)

The polyetherimide resin can have a weight average molecular weight (Mw) within a range having a lower limit and/or an upper limit. The range can include or exclude the lower limit and/or the upper limit. The lower limit and/or upper limit can be selected from 5000, 6000, 7000, 8000, 9000, 10000, 11000, 12000, 13000, 14000, 15000, 16000, 17000, 18000, 19000, 20000, 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000, 45000, 46000, 47000, 48000, 49000, 50000, 51000, 52000, 53000, 54000, 55000, 56000, 57000, 58000, 59000, 60000, 61000, 62000, 63000, 64000, 65000, 66000, 67000, 68000, 69000, 70000, 71000, 72000, 73000, 74000, 75000, 76000, 77000, 78000, 79000, 80000, 81000, 82000, 83000, 84000, 85000, 86000, 87000, 88000, 89000, 90000, 91000, 92000, 93000, 94000, 95000, 96000, 97000, 98000, 99000, 100000, 101000, 102000, 103000, 104000, 105000, 106000, 107000, 108000, 109000, and 110000 daltons. For example, the polyetherimide resin can have a weight average molecular weight (Mw) from 5,000 to 100,000 daltons, from 5,000 to 80,000 daltons, or from 5,000 to 70,000 daltons. The primary alkyl amine modified polyetherimide will have lower molecular weight and higher melt flow than the starting, unmodified, polyetherimide.

The polyetherimide resin can be selected from the group consisting of a polyetherimide, for example as described in U.S. Pat. Nos. 3,875,116; 6,919,422 and 6,355,723 a silicone polyetherimide, for example as described in U.S. Pat. Nos. 4,690,997: 4,808,686 a polyetherimide sulfone resin, as described in U.S. Pat. No. 7,041,773 and combinations thereof, incorporated herein their entirety.

The polyetherimide resin can be a silicone polyetherimide comprising a dimethyl silicone in an amount within a range having a lower limit and/or an upper limit. The range can include or exclude the lower limit and/or the upper limit. The lower limit and/or upper limit can be selected from 0, 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, and 60 weight percent. For example, the polyetherimide resin can be a silicone polyetherimide comprising from 1 to 40 weight percent of a dimethyl silicone, or from 5 to 40 weight percent of a dimethyl silicone. The polyetherimide resin can be a silicone polyetherimide comprising an amount of a dimethyl silicone, as described above, the dimethyl silicone can have a silicone block length within a range having a lower limit and/or an upper limit. The range can include or exclude the lower limit and/or the upper limit. The lower limit and/or upper limit can be selected from 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, and 75 silicone repeat units. For example, the polyetherimide resin can be a silicone polyetherimide comprising from 5 to 40 repeat units of a dimethyl silicone that is, having a silicone block length of 5 to 50 repeat units.

The polyetherimide resin can have a glass transition temperature within a range having a lower limit and/or an upper limit. The range can include or exclude the lower limit and/or the upper limit. The lower limit and/or upper limit can be selected from 100, 110, 120, 130, 140, 150, 160, 170, 180, 190, 200, 210, 220, 230, 240, 250, 260, 270, 280, 290, and 300 degrees Celsius (° C.). For example, the polyetherimide resin can have a glass transition temperature (Tg) greater than about 200° C.

The polyetherimide resin can be substantially free of benzylic protons. The polyetherimide resin can be free of benzylic protons. The polyetherimide resin can have an amount of benzylic protons below 100 ppm. In one embodiment, the amount of benzylic protons ranges from more than 0 to below 100 ppm. In another embodiment, the amount of benzylic protons is not detectable.

The polyetherimide resin can be substantially free of halogen atoms. The polyetherimide resin can be free of halogen atoms. The polyetherimide resin can have an amount of halogen atoms below 100 ppm. In one embodiment, the amount of halogen atoms ranges from more than 0 to below 100 ppm. In another embodiment, the amount of halogen atoms is not detectable.

The polyetherimide (PEI) can include a phosphorus-containing stabilizer in an amount that is effective to increase the melt stability of the polyetherimide, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300° C. at a heating rate of a 20° C. per minute under an inert atmosphere.

Alternatively, the phosphorous stabilizer can be introduced as a component of a polyetherimide thermoplastic resin composition comprising (a) a polyetherimide resin, and, (b) a phosphorous-containing stabilizer. A preferred phosphorous-containing stabilizer for the polyetherimide resin is described in U.S. Pat. No. 6,001,957, the entire disclosure of which is herein incorporated by reference. The phosphorous-containing stabilizer is present in an amount effective to increase the melt stability of the polyetherimide resin, wherein the phosphorous-containing stabilizer exhibits a low volatility such that, as measured by gravimetric analysis of an initial amount of a sample of the phosphorous-containing stabilizer, greater than or equal to 10% by weight of the initial amount of the sample remains unevaporated upon heating the sample from room temperature to 300° C. at a heating rate of 20° C. per minute under an inert atmosphere, wherein the phosphorous-containing compound is a compound according to the structural formula P—R¹ₐ, wherein each R¹ is independently H, alkyl, alkoxyl, aryl, aryloxy or oxo, and a is 3 or 4. For example, according to certain preferred embodiments, the composition can include a phosphorus stabilizer in an amount of between 0.01-10 wt %, 0.05-10 wt %, or from 5 to 10 wt %.

According to various embodiments, either layer, particularly the outer layer 4 can comprise a fluoropolymer. The fluoropolymer can be selected from copolymers of hexafluoropropylene and tetrafluoroethylene, such as fluorinated ethylene propylene (FEP); polytetrafluoroethylene (PTFE); perfluoroalkoxy polymer resin (PFA); polyvinylidene difluoride (PVDF); polyvinyl fluoride (PVF); ethylene tetrafluoroethylene (ETFE); and combinations thereof. For high temperature applications, FEP, PTFE, and PFA are preferred. For purposes of the present disclosure, high temperature applications are applications where temperatures exceed 200° C. For low temperature, PVDF, PVF, and ETFE are preferred. For purposes of the present disclosure, low temperature applications are applications where temperatures are less than or equal to 200° C.

According to various embodiments, a single layer coating can be employed instead of an innermost layer 3 and an outer layer 4. The single layer can comprise a fluorinated polyimide. The single layer can have the same properties as the dual-layer coating described in other embodiments. In another embodiment, a single layer can comprise blends of the polyetherimide and a fluoropolymer.

The construction of magnet wire and the materials specifically described within is not necessary limited to inner and outer layers, and thus is possible to order the materials as requirements change on a metal conductor. It is also reasonable to extend the invention to include more than two layers since co-extrusion or tandem extrusion technology is available to increase the number of layers.

It is understood from this invention, other additives such as pigments, dyes, glass, carbon fiber, mica and talc (to list a few) or combinations thereof and in combination with/without each layer is to be included in the invention. It is also understood, a constituent from the innermost layer may also be used in the outermost layer for the purpose of improving adhesion between the layers, among other properties.

The wire coatings according to various embodiments can be used in high temperature magnet wire for use in hybrid and electrical vehicles, as well as in transformers, motors, generators, alternators, solenoids and relays.

One embodiment relates to a wire having a composite coating thereon. The wire can be an elongated electrically conductive wire. The electrically conductive wire can include a metallic conductor. The wire can be a metal selected from aluminum, copper, and combinations thereof. The cross-sectional shape of the wire can be one selected from circular and rectangular.

The composite coating can be in contact with the metallic conductor. The composite coating can include a first layer including a thermoplastic polyetherimide (PEI) and a second layer including a thermoplastic fluoropolymer (FPM). The PEI can contain at least one additive selected from the group consisting of pigments, dyes, glass, carbon fiber, mica, talc, and stabilizer. The layer of FPM can be in contact with the metallic conductor. The layer of PEI can be in contact with the metallic conductor. The ratio of the thickness of PEI/FPM can be within a range having a lower limit and/or an upper limit. The range can include or exclude the lower limit and/or the upper limit. The lower limit and/or upper limit can be selected from 0, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.6, 4.65, 4.7, 4.75, 4.8, 4.85, 4.9, 4.95, 5, 5.05, 5.1, 5.15, 5.2, 5.25, 5.3, 5.35, 5.4, 5.45, 5.5, 5.55, 5.6, 5.65, 5.7, 5.75, 5.8, 5.85, 5.9, 5.95, 6, 6.05, 6.1, 6.15, 6.2, 6.25, 6.3, 6.35, 6.4, 6.45, 6.5, 6.55, 6.6, 6.65, 6.7, 6.75, 6.8, 6.85, 6.9, 6.95, and 7. For example, according to certain preferred embodiments, the ratio of the thickness of PEI/FPM can range from more than 0 to less than 5.4.

The wire can be coated with a composite thermoplastic coating having a dielectric constant (Dk) within a range having a lower limit and/or an upper limit. The range can include or exclude the lower limit and/or the upper limit. The lower limit and/or upper limit can be selected from 0, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.6, 4.65, 4.7, 4.75, 4.8, 4.85, 4.9, 4.95, and 5, when tested at 1 KHz at room temperature and 50% relative humidity. For example, according to certain preferred embodiments, the wire can be coated with a composite thermoplastic coating having a dielectric constant (Dk) of less than 3, when tested at 1 KHz at room temperature and 50% relative humidity.

The composite thermoplastic coating can include a layer of thermoplastic polyetherimide (PEI) and another layer being a thermoplastic fluoropolymer (FPM).

The composite thermoplastic coating can have a dissipation factor within a range having a lower limit and/or an upper limit. The range can include or exclude the lower limit and/or the upper limit. The lower limit and/or upper limit can be selected from 0, 0.0001, 0.0002, 0.0003, 0.0004, 0.0005, 0.0006, 0.0007, 0.0008, 0.0009, 0.001, 0.0011, 0.0012, 0.0013, 0.0014, 0.0015, 0.0016, 0.0017, 0.0018, 0.0019, 0.002, 0.0021, 0.0022, 0.0023, 0.0024, 0.0025, 0.0026, 0.0027, 0.0028, 0.0029, 0.003, 0.0031, 0.0032, 0.0033, 0.0034, 0.0035, 0.0036, 0.0037, 0.0038, 0.0039, 0.004, 0.0041, 0.0042, 0.0043, 0.0044, 0.0045, 0.0046, 0.0047, 0.0048, 0.0049, 0.005, 0.0051, 0.0052, 0.0053, 0.0054, 0.0055, 0.0056, 0.0057, 0.0058, 0.0059, 0.006, 0.0061, 0.0062, 0.0063, 0.0064, 0.0065, 0.0066, 0.0067, 0.0068, 0.0069, 0.007, 0.0071, 0.0072, 0.0073, 0.0074, 0.0075, 0.0076, 0.0077, 0.0078, 0.0079, 0.008, 0.0081, 0.0082, 0.0083, 0.0084, 0.0085, 0.0086, 0.0087, 0.0088, 0.0089, 0.009, 0.0091, 0.0092, 0.0093, 0.0094, 0.0095, 0.0096, 0.0097, 0.0098, 0.0099, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, 0.5, 0.51, 0.52, 0.53, 0.54, 0.55, 0.56, 0.57, 0.58, 0.59, 0.6, 0.61, 0.62, 0.63, 0.64, 0.65, 0.66, 0.67, 0.68, 0.69, 0.7, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, 1, 1.01, 1.02, 1.03, 1.04, 1.05, 1.06, 1.07, 1.08, 1.09, 1.1, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.31, 1.32, 1.33, 1.34, 1.35, 1.36, 1.37, 1.38, 1.39, 1.4, 1.41, 1.42, 1.43, 1.44, 1.45, 1.46, 1.47, 1.48, 1.49, 1.5, 1.51, 1.52, 1.53, 1.54, 1.55, 1.56, 1.57, 1.58, 1.59, 1.6, 1.61, 1.62, 1.63, 1.64, 1.65, 1.66, 1.67, 1.68, 1.69, 1.7, 1.71, 1.72, 1.73, 1.74, 1.75, 1.76, 1.77, 1.78, 1.79, 1.8, 1.81, 1.82, 1.83, 1.84, 1.85, 1.86, 1.87, 1.88, 1.89, 1.9, 1.91, 1.92, 1.93, 1.94, 1.95, 1.96, 1.97, 1.98, 1.99, and 2%, when tested at 1 KHz at room temperature and 50% relative humidity. For example, according to certain preferred embodiments, the composite thermoplastic coating can have a dissipation factor that is less than 1%, when tested at 1 KHz at room temperature and 50% relative humidity.

The composite thermoplastic coating can have a dielectric breakdown strength within a range having a lower limit and/or an upper limit. The range can include or exclude the lower limit and/or the upper limit. The lower limit and/or upper limit can be selected from 0, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 525, 550, 575, 600, 625, 650, 675, 700, 725, 750, 775, 800, 825, 850, 875, 900, 925, 950, 975, and 1000 kV/mm after aging at 200° C. for 2000 hours. For example, according to certain preferred embodiments, the composite thermoplastic coating can have a dielectric breakdown strength greater than 4 kV/mm after aging at 200° C. for 2000 hours.

Advantageously, it is now possible to make thermoplastic wire coatings that have a useful combination of electrical, process and mechanical properties that are suitable for many applications.

The composite thermoplastic coating can withstand voltage overloads or surges within a range having a lower limit and/or an upper limit. The range can include or exclude the lower limit and/or the upper limit. The lower limit and/or upper limit can be selected from 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, 1500, 1510, 1520, 1530, 1540, 1550, 1560, 1570, 1580, 1590, 1600, 1610, 1620, 1630, 1640, 1650, 1660, 1670, 1680, 1690, 1700, 1710, 1720, 1730, 1740, 1750, 1760, 1770, 1780, 1790, 1800, 1810, 1820, 1830, 1840, 1850, 1860, 1870, 1880, 1890, 1900, 1910, 1920, 1930, 1940, 1950, 1960, 1970, 1980, 1990, 2000, 2010, 2020, 2030, 2040, 2050, 2060, 2070, 2080, 2090, 2100, 2110, 2120, 2130, 2140, 2150, 2160, 2170, 2180, 2190, 2200, 2210, 2220, 2230, 2240, 2250, 2260, 2270, 2280, 2290, 2300, 2310, 2320, 2330, 2340, 2350, 2360, 2370, 2380, 2390, 2400, 2410, 2420, 2430, 2440, 2450, 2460, 2470, 2480, 2490, 2500, 2510, 2520, 2530, 2540, 2550, 2560, 2570, 2580, 2590, 2600, 2610, 2620, 2630, 2640, 2650, 2660, 2670, 2680, 2690, 2700, 2710, 2720, 2730, 2740, 2750, 2760, 2770, 2780, 2790, 2800, 2810, 2820, 2830, 2840, 2850, 2860, 2870, 2880, 2890, 2900, 2910, 2920, 2930, 2940, 2950, 2960, 2970, 2980, 2990, and 3000 V. For example, according to certain preferred embodiments, the composite thermoplastic coating can withstand voltage overloads or surges of greater than or equal to 600 V and more preferably greater than or equal to 1500 V.

The composite thermoplastic coating can have a volume resistivity within a range having a lower limit and/or an upper limit. The range can include or exclude the lower limit and/or the upper limit. The lower limit and/or upper limit can be selected from 1×10¹⁵, 1×10¹⁶, 1×10¹⁷, 1×10¹⁵, and 1×10¹⁹ ohm-cm. For example, according to certain preferred embodiments, the composite thermoplastic coating can have a volume resistivity of greater than 1×10¹⁷ ohm-cm.

The composite thermoplastic coating can possess a variety of beneficial environmental properties, including excellent heat shock resistance, hydro-stability, Automatic Transmission Fluid (ATF) oil chemical resistance, and Flammability/Smoke/Toxicity (FST) resistance.

In various applications the composite thermoplastic coatings will have to perform across a broad temperature range with exposure to sudden changes in temperature and heat flux. Therefore, thermal shock resistance of the composite thermoplastic coatings can be a critical factor in determining the durability of the component under transient thermal conditions. The composite thermoplastic coating can have a property retention, when exposed to a thermal shock of −40° C. for 30 minutes or to a thermal shock of 160° C. for 30 minutes, within a range having a lower limit and/or an upper limit. The range can include or exclude the lower limit and/or the upper limit. The lower limit and/or upper limit can be selected from 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100%, when exposed to a thermal shock of −40° C. for 30 minutes or to a thermal shock of 160° C. for 30 minutes. For example, according to certain preferred embodiments, the composite thermoplastic coating can have a property retention of greater than or equal to 80%, when exposed to a thermal shock of −40° C. for 30 minutes or to a thermal shock of 160° C. for 30 minutes.

The composite thermoplastic coating, and as such the corresponding coated wire, can exhibit excellent Hydro Stability. The composite thermoplastic can exhibit a property retention within a range having a lower limit and/or an upper limit. The range can include or exclude the lower limit and/or the upper limit. The lower limit and/or upper limit can be selected from 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100%, when exposed to an environment having a temperature of 85° C. and an 85% relative humidity (RH) for 2000 hours. For example, according to certain preferred embodiments, the composite thermoplastic can exhibit a property retention of greater than 80%, when exposed to an environment having a temperature of 85° C. and an 85% relative humidity (RH) for 2000 hours.

The composite thermoplastic coating can have excellent ATF Oil Chemical Resistance. The composite can exhibit a property retention within a range having a lower limit and/or an upper limit. The range can include or exclude the lower limit and/or the upper limit. The lower limit and/or upper limit can be selected from 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100%, when exposed to ATF Oil at 150° C. for 2000 hours. For example, according to certain preferred embodiments, the composite can exhibit a property retention of greater than 80%, when exposed to ATF Oil at 150° C. for 2000 hours.

The composite thermoplastic coating, and as such the corresponding coated wire, can have excellent Flammability/Smoke/Toxicity resistance. Such properties are known and can include coatings that can exhibit one or more of the following properties: a time to peak heat release of more than 150 seconds, as measured by FAR 25.853 (OSU test); a peak heat release less than or equal to 35 kW/m² as measured by FAR 25.853 (OSU test); an NBS (National Bureau of Standards) optical smoke density w/flame of less than 5 when measured at four (4) minutes, based on ASTM E-662 (FAR/JAR 25.853); and a toxic gas release of less than or equal to 100 ppm based on Draeger Tube Toxicity test (Airbus ABD0031, Boeing BSS 7239).

The composite thermoplastic coating can retain a percentage of its mechanical properties within a range having a lower limit and/or an upper limit. The range can include or exclude the lower limit and/or the upper limit. The lower limit and/or upper limit can be selected from 50, 55, 60, 65, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100% after aging at 200° C. for 2000 hours. For example, according to certain preferred embodiments, the composite thermoplastic coating can retain a percentage of its mechanical properties of greater than 80% after aging at 200° C. for 2000 hours.

The electrically conductive wire and composite thermoplastic coating can be suitable for continuous use at a temperature within a range having a lower limit and/or an upper limit. The range can include or exclude the lower limit and/or the upper limit. The lower limit and/or upper limit can be selected from 170, 171, 172, 173, 174, 175, 176, 177, 178, 179, 180, 181, 182, 183, 184, 185, 186, 187, 188, 189, 190, 195, 200, 205, 210, 215, 220, 225, 230, 235, 240, 245, 250, 255, 260, 265, 270, 275, 280, 285, 290, 295, 300, 325, 350, 375, 400, 425, 450, 475, 500, 525, 550, 575, 600, 625, 650, 675, 700, 725, 750, 775, 800, 825, 850, 875, 900, 925, 950, 975, and 1000° C. For example, according to certain preferred embodiments, the electrically conductive wire and composite thermoplastic coating can be suitable for continuous use at a temperature in excess of 180° C.

The composite thermoplastic coating can have a tensile elongation prior to break within a range having a lower limit and/or an upper limit. The range can include or exclude the lower limit and/or the upper limit. The lower limit and/or upper limit can be selected from 10, 11, 12, 13, 14, 15, 16, 17, 18, 19, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, and 200% prior to heat aging. For example, according to certain preferred embodiments, the composite thermoplastic coating can have a tensile elongation prior to break of greater than 15% prior to heat aging.

According to certain embodiments, the composite thermoplastic coated wire exhibits no cracks in the composite thermoplastic coating in a flatwise and edgewise bend. Additionally or alternatively, the composite thermoplastic coated wire can exhibit no visible cracks in the composite thermoplastic coating after winding the magnet wire.

The composite thermoplastic coating can include two distinct layers, one layer being a thermoplastic polyetherimide (PEI) and another layer being a thermoplastic fluoropolymer (FPM). The ratio of the thickness of PEI/FPM can be within a range having a lower limit and/or an upper limit. The range can include or exclude the lower limit and/or the upper limit. The lower limit and/or upper limit can be selected from 0, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.6, 4.65, 4.7, 4.75, 4.8, 4.85, 4.9, 4.95, 5, 5.05, 5.1, 5.15, 5.2, 5.25, 5.3, 5.35, 5.4, 5.45, 5.5, 5.55, 5.6, 5.65, 5.7, 5.75, 5.8, 5.85, 5.9, 5.95, 6, 6.05, 6.1, 6.15, 6.2, 6.25, 6.3, 6.35, 6.4, 6.45, 6.5, 6.55, 6.6, 6.65, 6.7, 6.75, 6.8, 6.85, 6.9, 6.95, and 7. For example, according to certain preferred embodiments, the ratio of the thickness of PEI/FPM can range from more than zero to less than 5.4.

According to various embodiments, the composite thermoplastic coating can adhere to the electrically conductive wire. The fluoropolymer can be perfluoroalkoxy polymer.

The thickness of the composite plastic coating can be within a range having a lower limit and/or an upper limit. The range can include or exclude the lower limit and/or the upper limit. The lower limit and/or upper limit can be selected from 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, and 250 micrometers. For example, according to certain preferred embodiments, the thickness of the composite plastic coating can range from more than zero to less than 200 micrometers.

According to various embodiments, the magnet wire can have two or more layers. The layer of coating adjacent the wire can be a thermoplastic polymer selected from the group consisting of polyetherimide, polyetherimide sulfone, polyetherimide siloxane, polysulfone, polyethersulfone, polyphenylsulfone, polycarbonate, polycarbonate siloxane, polyester-polycarbonate (as homopolymers, block copolymers or random copolymers) and blends thereof; and the other layer is a fluoropolymer (FPM) selected from the group consisting of polytetrafluoroethylene (PTFE), perfluoroalkoxy (PFA), ethylene tetrafluoroethylene (ETFE) fluorinated ethylene propylene (FEP) copolymers and blends of the foregoing, and combinations thereof.

A particularly preferred embodiment relates to a magnet wire comprising a composite coating thereon, said magnet wire comprising: an elongated electrically conductive wire; said wire being coated with a composite thermoplastic coating having a dielectric constant (Dk) of less than 3, when tested at 1 KHz at room temperature and 50% relative humidity, wherein the composite thermoplastic coating has a dissipation factor that is less than 1%, when tested at 1 KHz at room temperature and 50% relative humidity; wherein the composite thermoplastic coating comprises two distinct layers, one layer being a thermoplastic polyetherimide (PEI) and another layer being a thermoplastic perfluoroalkoxy (PFA), and wherein the ratio of the thickness of PEI/PFA ranges from more than zero to less than 5.4; and, wherein the thickness of the composite plastic coating ranges from more than zero to less than 200 micrometers. The polyetherimide (PEI) can include a phosphorus-containing stabilizer in an amount that is effective to increase the melt stability of the polyetherimide, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300° C. at a heating rate of a 20° C. per minute under an inert atmosphere. In some embodiments, the phosphorous-containing stabilizer has a formula P—R′a, where each R′ is independently H, C1-C12 alkyl, C1-C12 alkoxy, C6-C12 aryl, C6-C12 aryloxy, or oxy substituent, and a is 3 or 4. Examples of such suitable stabilized polyetherimides can be found in U.S. Pat. No. 6,001,957, incorporated herein in its entirety.

The composite thermoplastic coating can be “solvent free.” For purposes of the present disclosure the term “solvent free” means that the composite thermoplastic coating contains less than 500 ppm of any type of solvent. A solvent free composite thermoplastic coating can include an amount of solvent within a range having a lower limit and/or an upper limit. The range can include or exclude the lower limit and/or the upper limit. The lower limit and/or upper limit can be selected from 0, 2, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100, 102, 104, 106, 108, 110, 112, 114, 116, 118, 120, 122, 124, 126, 128, 130, 132, 134, 136, 138, 140, 142, 144, 146, 148, 150, 152, 154, 156, 158, 160, 162, 164, 166, 168, 170, 172, 174, 176, 178, 180, 182, 184, 186, 188, 190, 192, 194, 196, 198, 200, 202, 204, 206, 208, 210, 212, 214, 216, 218, 220, 222, 224, 226, 228, 230, 232, 234, 236, 238, 240, 242, 244, 246, 248, 250, 252, 254, 256, 258, 260, 262, 264, 266, 268, 270, 272, 274, 276, 278, 280, 282, 284, 286, 288, 290, 292, 294, 296, 298, 300, 302, 304, 306, 308, 310, 312, 314, 316, 318, 320, 322, 324, 326, 328, 330, 332, 334, 336, 338, 340, 342, 344, 346, 348, 350, 352, 354, 356, 358, 360, 362, 364, 366, 368, 370, 372, 374, 376, 378, 380, 382, 384, 386, 388, 390, 392, 394, 396, 398, 400, 402, 404, 406, 408, 410, 412, 414, 416, 418, 420, 422, 424, 426, 428, 430, 432, 434, 436, 438, 440, 442, 444, 446, 448, 450, 452, 454, 456, 458, 460, 462, 464, 466, 468, 470, 472, 474, 476, 478, 480, 482, 484, 486, 488, 490, 492, 494, 496, 498, and 500 ppm. For example, according to certain preferred embodiments, a solvent free composite thermoplastic coating can include an amount of solvent of from 0 to 500 ppm. The types of solvents that can be included or excluded from the composite thermoplastic coating can include but are not limited to polar solvents, non-polar solvents, and combinations thereof. Examples of some solvents include and are not limited to meta-cresol, ortho-dichlorobenzene (ODCB), anisole, N-methyl pyrrolidone, and combinations thereof.

The composite thermoplastic coating can further include a fluoropolymer in an amount within a range having a lower limit and/or an upper limit. The range can include or exclude the lower limit and/or the upper limit. The lower limit and/or upper limit can be selected from 0, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, and 50%, based on the weight of the thermoplastic coating. For example, according to certain preferred embodiments, the composite thermoplastic coating can further include a fluoropolymer in an amount ranging from more than 0 and less than or equal to 20 weight %, based on the weight of the thermoplastic coating.

The wire can be selected from the group of electrical wire, magnet wire, winding wire, magnetic coil wire, electromagnetic wire coil, electromagnetic wire, and combinations thereof.

Another embodiment relates to a method of making the magnet wires and coated wires described above. The methods can include extruding onto an elongated electrically conducting wire a first layer of a thermoplastic polymer into contact with the wire and forming a second layer of a different thermoplastic polymer onto the first layer.

The first and second layers can be co-extruded onto the wire. The second layer can be a fluoropolymer. The first layer can be a polymer selected from the group consisting of polyetherimide, polyetherimide sulfone, polyetherimide siloxane, polysulfone, polyethersulfone, polyphenylsulfone, polycarbonate, polycarbonate siloxane, polyester-polycarbonate (as homopolymers, block copolymers or random copolymers) and blends thereof. The first layer can be a polyetherimide (PEI) and the second layer is perfluoroalkoxy (PFA).

The ratio of thickness of PEI/PFA can be within a range having a lower limit and/or an upper limit. The range can include or exclude the lower limit and/or the upper limit. The lower limit and/or upper limit can be selected from 0, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.6, 4.65, 4.7, 4.75, 4.8, 4.85, 4.9, 4.95, 5, 5.05, 5.1, 5.15, 5.2, 5.25, 5.3, 5.35, 5.4, 5.45, 5.5, 5.55, 5.6, 5.65, 5.7, 5.75, 5.8, 5.85, 5.9, 5.95, 6, 6.05, 6.1, 6.15, 6.2, 6.25, 6.3, 6.35, 6.4, 6.45, 6.5, 6.55, 6.6, 6.65, 6.7, 6.75, 6.8, 6.85, 6.9, 6.95, and 7. For example, according to certain preferred embodiments, the ratio of thickness of PEI/PFA can be in a range of greater than zero to less than 5.4.

The thickness of the first and second layers can be within a range having a lower limit and/or an upper limit. The range can include or exclude the lower limit and/or the upper limit. The lower limit and/or upper limit can be selected from 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, and 250 micrometers. For example, according to certain preferred embodiments, the thickness of the first and second layers can be greater than zero and less than 200 micrometers.

The method can be “solvent free.” For purposes of the present disclosure the term “solvent free” means that the method produces a composite thermoplastic coating contains less than 500 ppm of any type of solvent. A solvent free composite thermoplastic coating can include an amount of solvent within a range having a lower limit and/or an upper limit. The range can include or exclude the lower limit and/or the upper limit. The lower limit and/or upper limit can be selected from 0, 2, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100, 102, 104, 106, 108, 110, 112, 114, 116, 118, 120, 122, 124, 126, 128, 130, 132, 134, 136, 138, 140, 142, 144, 146, 148, 150, 152, 154, 156, 158, 160, 162, 164, 166, 168, 170, 172, 174, 176, 178, 180, 182, 184, 186, 188, 190, 192, 194, 196, 198, 200, 202, 204, 206, 208, 210, 212, 214, 216, 218, 220, 222, 224, 226, 228, 230, 232, 234, 236, 238, 240, 242, 244, 246, 248, 250, 252, 254, 256, 258, 260, 262, 264, 266, 268, 270, 272, 274, 276, 278, 280, 282, 284, 286, 288, 290, 292, 294, 296, 298, 300, 302, 304, 306, 308, 310, 312, 314, 316, 318, 320, 322, 324, 326, 328, 330, 332, 334, 336, 338, 340, 342, 344, 346, 348, 350, 352, 354, 356, 358, 360, 362, 364, 366, 368, 370, 372, 374, 376, 378, 380, 382, 384, 386, 388, 390, 392, 394, 396, 398, 400, 402, 404, 406, 408, 410, 412, 414, 416, 418, 420, 422, 424, 426, 428, 430, 432, 434, 436, 438, 440, 442, 444, 446, 448, 450, 452, 454, 456, 458, 460, 462, 464, 466, 468, 470, 472, 474, 476, 478, 480, 482, 484, 486, 488, 490, 492, 494, 496, 498, and 500 ppm. For example, according to certain preferred embodiments, a solvent free composite thermoplastic coating can include an amount of solvent of from 0 to 500 ppm. The types of solvents that can be included or excluded from the composite thermoplastic coating can include but are not limited to polar solvents, non-polar solvents, and combinations thereof. Examples of some solvents include and are not limited to meta-cresol, ortho-dichlorobenzene (ODCB), anisole, N-methyl pyrrolidone, and combinations thereof.

The present invention may be understood more readily by reference to the following detailed description of preferred embodiments of the invention as well as to the examples included therein. All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

The invention is further described in the following illustrative examples in which all parts and percentages are by weight unless otherwise indicated.

### EXAMPLES

### Examples 1-8

A purpose of Examples 1-8 was to demonstrate a dual layer protective electrical insulation coating of less than 0.20 mm thickness on a metal conductor using high temperature thermoplastic materials can achieve a dielectric constant (Dk) of <2.8 and low dissipation factor (Df) at 1 kHz and 23 C. Table 1 summarizes materials used in Examples 1-8.

TABLE 1

| Component | Chemical Description | Trade name | Material Type | Supplier |
|---|---|---|---|---|
| Coating | Polyetherimide Sulfone | Ultem | Thermoplastic | SABIC |
| | (PEIS) | XH6050 | (pellets) | |
| Coating | Perfluoroalkoxy (PFA) | Teflon PFA | Thermoplastic | DuPont |
| | Fluoropolymer | 420 HP-J | (pellets) | |
| Conductor | Copper Wire | | Metal | |
| | (1.2 mm O.D) | | (wire) | |

The materials described in Table 1 were extruded on a 25 mm Hijiri single screw extruder with L/D of 24 with a vacuum vented full flight screw, at a barrel and die head temperature between 350 and 390° C. and 5.4 to 15.4 rpm screw speed. The metal conductor was preheated to 150° C. with line speed of 23 to 25 m/min. The extrudate and metal conductor was cooled in air prior to winding on a spool. Ultem XH6050 pellets were dried in a forced air convention oven dryer at 220° C. for 8 hours, while Teflon PFA 420 HP-J was not dried and processed as received from the supplier. The two layers were extruded on the metal conductor using a sequential process with the first innermost layer extruded directly on the metal conductor with a thickness of 0.050 to 0.100 mm based on material used to construct the layer. The second outermost layer was than extruded directly on the first layer with a material not used as a first layer, and was done in a second extrusion step using the same process equipment. This resulted in a dual layer construction with a first layer nearest the conductor of one type of material (ex: PEIS) and a second outermost layer with the other material (ex: PFA) which covered the first layer. Table 2 summarizes the results obtained.

TABLE 2

| | PEIS | PFA | PEIS/PFA | Dk @ | Df @ | |
|---|---|---|---|---|---|---|
| | Thickness | Thickness | Thickness | 1 kHz, 23 C., | 1 kHz, 23 C., | |
| Ex. | (mm) | (mm) | Ratio | 50% RH | 50% RH | Comment |
| Single Layer Constructions | | | | | | |
| 1 | None | 0.061 | — | 1.931 | 0.0007 | |
| 2 | 0.105 | None | — | 3.301 | 0.0020 | |
| Dual Layer Constructions (order of layers: Metal/PFA/PEIS) | | | | | | |
| 3 | 0.061 | 0.061 | 1.00 | 2.210 | 0.262 | Poor |
| | | | | | | adhesion |
| 4 | 0.094 | 0.061 | 1.55 | 2.920 | 0.241 | Poor |
| | | | | | | adhesion |
| 5 | 0.110 | 0.061 | 1.82 | 2.956 | 0.160 | Poor |
| | | | | | | adhesion |
| Dual Layer Construction (order of layers: Metal/PEIS/PFA) | | | | | | |
| 6 | 0.105 | 0.039 | 2.71 | 2.914 | 0.175 | |
| 7 | 0.105 | 0.062 | 1.69 | 2.450 | 0.162 | |
| 8 | 0.105 | 0.084 | 1.24 | 2.124 | 0.121 | |

Examples 3-8 demonstrate the utility of various embodiment of the invention by combining high temperature thermoplastic materials in a dual layered structure on a metal conductor to obtain an electrically insulating coating with a dielectric constant (Dk) ranging from 2.124 to 2.956 at 1 kHz and 23° C. This is compared to examples 1 and 2 which are single layered coatings of PFA and PEIS with resulting Dk of 1.931 and 3.301 respectively. Examples 3-8 further demonstrate the invention by achieving an intermediate dielectric constant between the individual constituents may be obtained by changing the thickness of the PEIS layer relative to the PFA layer and is independent of overall total thickness of the coating. The ratio of PEIS/PFA in examples 3-8 ranged from 1.00 to 2.71 with an increasing ratio resulting in Dk near 100% PEIS and decreasing ratio approaching 100% PFA.

The experimental results in Table 1 also demonstrate the preferred order of the dual layer with PEIS as the innermost layer on the metal conductor and PFA as the outermost layer since adhesion to the metal conductor is much better and provides for a better electrically insulation coating. This is demonstrated in examples 3-5 with PFA as the innermost and PEIS as the outermost layer, the adhesion of PFA to the metal conductor was poor and resulted in a high dissipation factor (Df) with range of 0.160 to 0.262 as compared to with examples 6-8 and PEIS as the innermost layer. Examples 6-8 demonstrated good adhesion with a Df ranging from 0.121 to 0.175. The invention makes a clear distinction as to the preferred order of the materials relative to the metal conductor as well as the lowest dielectric constant material, between the two materials, as the outermost layer.

### Examples 9-14

A purpose of Examples 9-14 was to demonstrate combining high temperature injection molded plaques of polyetherimide sulfone (PEIS) and perfluoroalkoxy (PFA) fluoropolymer can obtain a dielectric constant (Dk) of <2.8 and dissipation factor (Df) of <1% at 1 kHz and 23° C. The experiment was to demonstrate the ratio of PEIS to PFA thickness determines Dk and Df of the dual layer construction. The materials employed in Examples 9-14 are summarized in

TABLE 3

| Component | Chemical Description | Trade name | Material Type | Supplier |
|---|---|---|---|---|
| Injection Molded | Polyetherimide Sulfone | Ultem | Thermoplastic | SABIC |
| Plaque | (PEIS) | XH6050 | (pellets) | Innovative |
| | | | | Plastics |
| Injection Molded | Perfluoroalkoxy (PFA) | Teflon PFA | Thermoplastic | DuPont |
| Plaque | Fluoropolymer | 420 HP-J | (pellets) | |

A 100-ton Toshiba EC100 injection molding machine with a 146 cm³ barrel was used to mold 100×100 cm plaques at two different thicknesses of 2.0 and 3.0 mm for Dk and Df electrical property testing. The materials were processed with barrel temperature settings using an increasing temperature profile from feed throat to barrel nozzle of 330 to 360° C. and 360 to 380° C. for PFA and PEIS respectively. The mold temperature was held constant at 160° C. for each material with a slow injection speed for PFA and fast for PEIS. PFA resin pellets were dried in a desiccant dryer at 150° C. for 3-4 hours while PEIS pellets were dried at 220° C. for 8 hours. The plaques were molded and tested using ASTM D150 standard with samples consisting of different combinations of PFA and PEIS plagues to change PEIS/PFA ratio and overall thickness in a layered configuration. The materials were placed between Ando Electric Company TR-1100 electrodes using a clamp to force direct contact between the plaques while Dk and Df were measured at 1 kHz at 23° C. and 50% RH. The results are summarized in Table 4.

TABLE 4

| | | PFA | PEIS | PEIS/PFA | Dk @ | Df @ |
|---|---|---|---|---|---|---|
| | Sample | Thickness | Thickness | Thickness | 1 kHz, 23 C., | 1 kHz, 23 C., |
| Ex. | Orientation | (mm) | (mm) | Ratio | 50% RH | 50% RH |
| 9 | PFA (A) | 1.85 | None | — | 2.00 | 0.00003 |
| 10 | PEIS (B) | None | 2.03 | — | 3.29 | 0.00170 |
| 11 | PEIS (C) | None | 3.02 | — | 3.30 | 0.00170 |
| 12 | (A) + (B) | 1.85 | 2.03 | 1.10 | 2.50 | 0.00068 |
| 13 | (A) + (C) | 1.85 | 3.02 | 1.63 | 2.62 | 0.00088 |
| 14 | (A) + (B) + (B) | 1.85 | 4.06 | 2.19 | 2.73 | 0.00092 |

Examples 12-14, demonstrate the utility of various embodiments of the invention by combining high temperature thermoplastic materials in a layered structure to achieve a Dk ranging from 2.50 to 2.73 and between PFA of 2.00 and PEIS of 3.29. Examples 12-14 also demonstrate the effect of increasing PEIS/PFA thickness ratio has on increasing the Dk for the resulting material construction. In addition to changing Dk, Df will increase although it remains extremely low and less than 1% which is a desired electrical characteristic to prevent thermal heating of the components when used in electrical motors, transformers, generators, alternators, solenoids and relays.

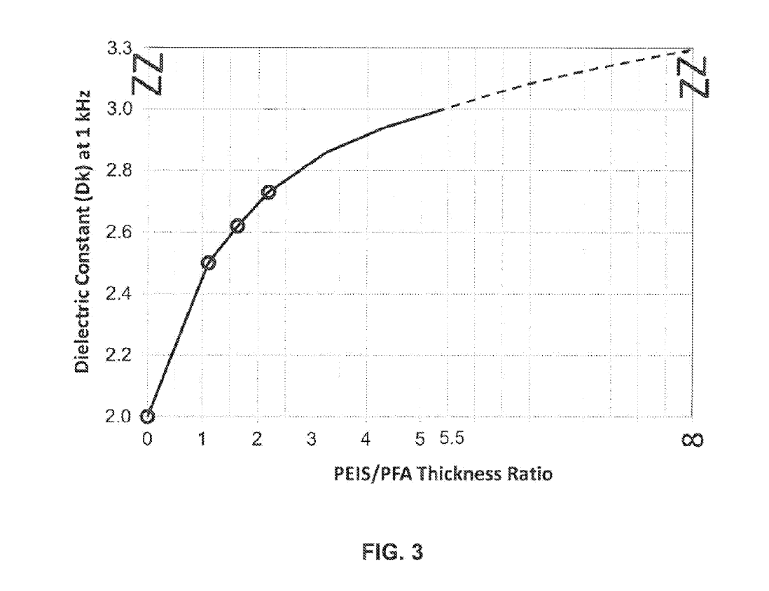

FIG. 3 presents Dielectric constant versus PEIS/PFA thickness ratio for experimental results presented in Table 4. The Dk of the layered structure will increase from 2.0, a layered structure consisting of 100% PFA, with an increase in PEIS/PFA thickness ratio until the layered structure reaches 100% PEIS and a value of 3.3. It is schematically presented in FIG. 3 with the thickness ratio increasing from 0 to a significantly large (infinity) number. People skilled in the art will appreciate the constraints of the layered system by the inherent material properties of the individual constituents regardless of their ratio. The useful range of the invention is with a PEIS/PFA ratio of less than 5.4 which results in a Dk<3.0.

A synopsis of all the relevant tests and test methods is given in Table 5.

TABLE 5

| | Test Standard | Default Specimen Type | Units |
|---|---|---|---|
| Dielectric | ASTM D150 | Coated Single Conductor Wire | No Units |
| Constant | | and Injection Molded Plaque | (ratio) |
| Dissipation | ASTM D150 | Coated Single Conductor Wire | % |
| Factor | | and Injection Molded Plaque | |
| Thickness | NEMA MW 1000 | Coated Single Conductor Wire | mm |
| Dimensions | Sec. 3.2 | | |
| Thickness | Calipers | Injection Molded Plaque | mm |
| Dimensions | | | |

Although the present invention has been described in considerable detail with reference to certain preferred versions thereof, other versions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

1. A wire comprising a composite coating thereon, said wire comprising:
an elongated electrically conductive wire;
said wire being coated with a composite thermoplastic coating having a dielectric constant (Dk) of less than 3, when tested at 1 KHz at room temperature and 50% relative humidity.

2. The wire of claim 1, wherein the composite thermoplastic coating has a dissipation factor that is less than 1%, when tested at 1 KHz at room temperature and 50% relative humidity.

3. The wire of claim 1, wherein the composite thermoplastic coating has a dielectric breakdown strength greater than 4 kV/mm after aging at 200° C. for 2000 hours.

4. The wire of claim 1, wherein the composite thermoplastic coating comprises two distinct layers, one layer being a thermoplastic polyetherimide (PEI) and another layer being a thermoplastic fluoropolymer (FPM).

5. The wire of claim 4, wherein the ratio of the thickness of PEI/FPM ranges from more than zero to less than 5.4.

6. The wire of claim 1, wherein the electrically conductive wire comprises a metallic conductor; and the composite thermoplastic coating comprises a layer of thermoplastic polyetherimide (PEI) and another layer being a thermoplastic fluoropolymer (FPM).

7. The wire of claim 6, wherein the layer of PEI is in contact with the metallic conductor.

8. The wire of claim 6, wherein the layer of FPM is in contact with the metallic conductor.

9. The wire of claim 6, wherein the ratio of the thickness of PEI/FPM ranges from more than zero to less than 5.4.

10. The wire of claim 1, wherein the thickness of the composite plastic coating ranges from more than zero to less than 200 micrometers.

11. The wire of claim 1, wherein the composite thermoplastic coating retains greater than 80% of its mechanical properties after aging at 200° C. for 2000 hours.

12. The wire of claim 1, wherein the electrically conductive wire and composite thermoplastic coating is suitable for continuous use at temperatures in excess of 180° C.

13. The wire of claim 1, wherein the composite thermoplastic coating has a tensile elongation prior to break of greater than 15% prior to heat aging.

14. The wire of claim 1, wherein the composite thermoplastic coated wire exhibits no cracks in the composite thermoplastic coating in a flatwise and edgewise bend.

15. The wire of claim 1, wherein the composite thermoplastic coated wire exhibits no visible cracks in the composite thermoplastic coating after winding the magnet wire.

16. The wire of claim 1, wherein the wire is a metal selected from aluminum, copper, and combinations thereof.

17. The wire of claim 16, wherein the cross-sectional shape of the wire is one selected from circular and rectangular.

18. The wire of claim 4, wherein the composite thermoplastic coating adheres to the electrically conductive wire.

19. The wire of claim 4, wherein the fluoropolymer is perfluoroalkoxy polymer.

20. The wire of claim 1, comprising two layers, wherein the layer of coating adjacent the wire is a thermoplastic polymer selected from the group consisting of polyetherimide, polyetherimide sulfone, polyetherimide siloxane, polysulfone, polyethersulfone, polyphenylsulfone, polycarbonate, polycarbonate siloxane, polyester-polycarbonate (as homopolymers, block copolymers or random copolymers) and blends thereof; and the other layer is a fluoropolymer (FPM) selected from the group consisting of polytetrafluoroethylene (PTFE), perfluoroalkoxy (PFA), ethylene tetrafluoroethylene (ETFE) fluorinated ethylene propylene (FEP) copolymers and blends of the foregoing, and combinations thereof.

21. The wire of claim 7, wherein the PEI contains at least one additive selected from the group consisting of pigments, dyes, glass, carbon fiber, mica, talc, and stabilizer.

22. The wire of claim 4, wherein the polyetherimide (PEI) comprises a phosphorus-containing stabilizer in an amount that is effective to increase the melt stability of the polyetherimide, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300° C. at a heating rate of a 20° C. per minute under an inert atmosphere.

23. The wire of claim 22, wherein the phosphorous-containing compound is a compound according to the structural formula P—R′a, wherein each R′ is independently H, C₁-C₁₂ alkyl, C₁-C₁₂ alkoxy, C₆-C₁₂ aryl, C₆-C₁₂ aryloxy, or oxy substituent, and a is 3 or 4.

24. A method of making a coated wire comprising extruding onto an elongated electrically conducting wire a first layer of a thermoplastic polymer into contact with the wire and forming a second layer of a different thermoplastic polymer onto the first layer.

25. The method of claim 24, wherein the first and second layers are co-extruded onto the wire.

26. The method of claim 25, wherein the second layer is a fluoropolymer.

27. The method of claim 24, wherein the first layer is a polymer selected from the group consisting of polyetherimide, polyetherimide sulfone, polyetherimide siloxane, polysulfone, polyethersulfone, polyphenylsulfone, polycarbonate, polycarbonate siloxane, polyester-polycarbonate (as homopolymers, block copolymers or random copolymers) and blends thereof.

28. The method of claim 24, wherein the first layer is a polyetherimide (PEI) and the second layer is perfluoroalkoxy (PFA).

29. The method of claim 28, wherein the ratio of thickness of PEI/PFA is in the range of greater than zero to less than 5.4.

30. The method of claim 29, wherein the thickness of the first and second layers is greater than zero and less than 200 micrometers.

31. The method of claim 24, wherein the method is solvent free.

32. A magnet wire comprising a composite coating thereon, said magnet wire comprising:
an elongated electrically conductive wire;
said wire being coated with a composite thermoplastic coating having a dielectric constant (Dk) of less than 3, when tested at 1 KHz at room temperature and 50% relative humidity, wherein the composite thermoplastic coating has a dissipation factor that is less than 1%, when tested at 1 KHz at room temperature and 50% relative humidity;
wherein the composite thermoplastic coating comprises two distinct layers, one layer being a thermoplastic polyetherimide (PEI) and another layer being a thermoplastic perfluoroalkoxy (PFA), and wherein the ratio of the thickness of PEI/PFA ranges from more than zero to less than 5.4; and,
wherein the thickness of the composite plastic coating ranges from more than zero to less than 200 micrometers.

33. The magnet wire of claim 32, wherein the polyetherimide (PEI) comprises a phosphorus-containing stabilizer in an amount that is effective to increase the melt stability of the polyetherimide, wherein the phosphorus-containing stabilizer exhibits a low volatility such that, as measured by thermogravimetric analysis of an initial amount of a sample of the phosphorus-containing stabilizer, greater than or equal to 10 percent by weight of the initial amount of the sample remains unevaporated upon heating of the sample from room temperature to 300° C. at a heating rate of a 20° C. per minute under an inert atmosphere.

34. The magnet wire of claim 33, wherein the phosphorous-containing compound is a compound according to the structural formula P—R′a, wherein each R′ is independently H, C₁-C₁₂ alkyl, C₁-C₁₂ alkoxy, C₆-C₁₂ aryl, C₆-C₁₂ aryloxy, or oxy substituent, and a is 3 or 4.

35. The magnet wire of claim 34, wherein the composition comprises the phosphorous-containing compound in an amount of from 0.01 to 10 wt %.

36. The wire of claim 1, wherein the composite thermoplastic coating is solvent free.

37. The wire of claim 1, wherein the composite thermoplastic coating further comprises a fluoropolymer in an amount ranging from more than 0 and less than or equal to 20 weight %, based on the weight of the thermoplastic coating.

38. The wire of claim 1, wherein the wire is selected from the group of electrical wire, magnet wire, winding wire, magnetic coil wire, electromagnetic wire coil, electromagnetic wire, and combinations thereof.
